(19) United States
(12) Patent Application Publication
(10) Pub. No.: US 2014/0284366 A1
(43) Pub. Date: Sep. 25, 2014

(54) METHOD OF CUTTING A TEMPERED GLASS SUBSTRATE

(71) Applicant: RORZE SYSTEMS CORPORATION, Yongin-si, Gyeonggi-do (KR)

(72) Inventors: Yong-Heum Cho, Seoul (KR); Hyuk Park, Seoul (KR); Seong-Wook Moon, Incheon (KR); Ki-Yong You, Seoul (KR)

(73) Assignee: RORZE SYSTEMS CORPORATION, Yomgin-si, Gyeonggi-do (KR)

(21) Appl. No.: 13/991,770

(22) PCT Filed: Apr. 3, 2012
(86) PCT No.: PCT/KR2012/002479

§ 371 Date: Jun. 5, 2013

(30) Foreign Application Priority Data
Dec. 9, 2011 (KR) 10-2011-131959

(51) Int. Cl. C03B 33/09

(52) U.S. Cl. CPC C03B 33/091
USPC 225/2

(57) ABSTRACT

A method of cutting a tempered glass substrate, which is capable of cut a tempered glass substrate without mechanical breaking process and cooling process , is disclosed. The method of cutting a tempered glass substrate, includes, forming an initial crack at a cut-starting point of the tempered glass substrate; forming a heated line at the tempered glass substrate by irradiating laser beam from a point different from the cut-starting point with the initial crack to the cut-starting point with the initial crack through optical heater; and automatically propagating the intimal crack along the heated line to cut the tempered glass substrate.

### TECHNICAL FIELD

Exemplary embodiments of the present invention relate to a method of cutting a tempered glass substrate. More particularly, exemplary embodiments of the present invention relate to a method of cutting a tempered glass substrate by using laser beam.

### BACKGROUND ART

In general, a mechanical cutting method, a chemical cutting method and a laser cutting method are used for cutting a tempered glass substrate. In the mechanical cutting method, a diamond wheel or a sand blaster is used. In the chemical cutting method, a wet etching is used. According to the mechanical cutting method, there exist problems of minute crack and particles on a surface of a tempered glass substrate. According to the chemical cutting method, there exists a problem of environmental pollution by chemicals and a problem of low productivity induced by long process time. Further, according to a conventional laser cutting method, an initial crack is formed, the initial crack is propagated by laser scribing from the initial crack, and a physical impact is applied to a tempered glass substrate by a breaker to cut the tempered substrate. However, the initial crack is not exactly propagated due to self-stress of the tempered glass substrate to deteriorate productivity.

Therefore, in order to solve the above-mentioned problems of the mechanical cutting method, the chemical cutting method and the laser cutting method, a method of cutting a tempered glass substrate by laser has been recently developed.

FIG. 1 is a schematic view illustrating a conventional method of cutting a tempered glass substrate by using laser beam.

Referring to FIG. 1, according to the conventional method of cutting a glass substrate or a tempered glass substrate by using laser beam, an initial crack 200 is formed at a cut-starting point of a glass substrate or a tempered glass substrate 20 by using an initial crack generator 10.

After forming the initial crack 200 at a cut-starting point of the tempered glass substrate 20, a laser beam 11 is irradiated from the cut-starting point with cut-starting point with the initial crack 200 to an cut-ending point of the tempered glass substrate 20 by using an optical heater (not shown) along a direction A to form a scribing line 13 from the cut-starting point with the initial crack 200 to the cut-ending point of the tempered glass substrate 20.

When forming the scribing line 13 from the cut-starting point with the initial crack 200 to the cut-ending point of the tempered glass substrate 20, along the heated scribing line 13, a cooling substance is sprayed from the cut-starting point with the initial crack 200 to the cut-ending point of the tempered glass substrate 20 by using a quenching nozzle 12 to cool down the scribing line 13 to propagate the initial crack 200 to cut the tempered glass substrate 20.

According to the conventional method of cutting a tempered glass substrate, the initial crack 200 is propagated along the scribing line 13 by heating and cooling down the scribing line 13. However, it is difficult to propagate the crack to a desired depth in case of the tempered glass substrate, and to maintain the crack along the scribing line 13.

### DISCLOSURE

### Technical Problem

Exemplary embodiments of the present invention provide a method of cutting a tempered glass substrate by only laser scribing without mechanical breaking and cooling down by using quenching nozzle, which is capable of enhancing a cutting speed, reducing micro crack, and reducing chipping and particles when cutting a tempered glass substrate.

### Technical Solution

The method of cutting a tempered glass substrate, includes, forming an initial crack at a cut-starting point of the tempered glass substrate; forming a heated line at the tempered glass substrate by irradiating laser beam from a point different from the cut-starting point with the initial crack to the cut-starting point with the initial crack through optical heater; and automatically propagating the intimal crack along the heated line to cut the tempered glass substrate.

The method may further include irradiating again the laser beam from the cut-starting point with the initial crack to a cut-ending point of the tempered glass substrate after the laser beam arrives at the initial crack.

For example, the laser beam may be irradiated onto the tempered glass substrate when the optical heater moves.

Alternatively, the laser beam may be irradiated onto the tempered glass substrate when the tempered glass substrate moves.

Alternatively, the laser beam may be irradiated onto the tempered glass substrate when the optical heater and the tempered glass substrate move in opposite direction with each other.

For example, the laser beam may be irradiated from a cut-ending point of the tempered glass substrate to the cut-starting point with the initial crack.

Alternatively, the laser beam may be irradiated from a point on a line between a cut-ending point and the cut-starting point to the cut-starting point with the initial crack.

### Advantageous Effects

According to the method of cutting a tempered glass substrate, the laser beam is irradiated on the tempered glass substrate from a point different from the cut-starting point with the initial crack to the cut-starting point, so that the heated line is formed when the laser beam arrives at the initial crack.

Therefore, when the laser beam arrives at the initial crack, the initial crack propagates from the initial crack along the heated line, so that the tempered glass substrate is clearly cut. As a result, it is prevented that the tempered glass substrate is cut along a curved line.

Further, according to the method of the present invention, the tempered glass substrate may be cut without micro crack in a sectional surface, chipping or particle only through a laser scribing process, but not through a mechanical breaking process.

Further, according to the method of the present invention, the tempered glass substrate may be cut only through the laser scribing process but not through the mechanical breaking process and a cooling process using quenching nozzle, so that the number of the process for cutting the tempered glass substrate is reduced to reduce a process time and a cost for manufacturing and maintaining an apparatus for cutting the tempered glass substrate.

### DESCRIPTION OF DRAWINGS

FIG. 1 is a schematic view illustrating a conventional method of cutting a tempered glass substrate by using laser beam.

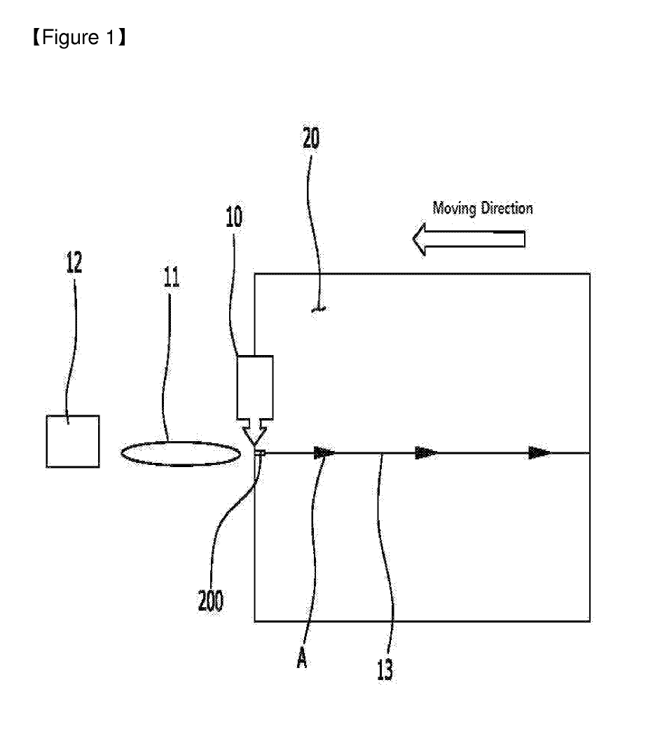

FIG. 2 is a schematic view illustrating an apparatus and a method of cutting a tempered glass substrate according to an exemplary embodiment of the present invention.

FIG. 3 is a schematic view illustrating a direction of cutting a tempered glass substrate.

### MODE FOR INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that, although the terms first, second, third etc. may be used herein to describe various elements, components, regions, layers and/or sections, these elements, components, and/or sections should not be limited by these terms. These terms are only used to distinguish one element, component, region, layer or section from another region, layer or section. Thus, a first element, component, or section discussed below could be termed a second element, component, or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For convenience, same numerals are used for identical or similar elements of an apparatus of cutting a tempered substrate and the conventional one.

Hereinafter, an apparatus of cutting a tempered glass substrate according to an exemplary embodiment of the present invention will be described with reference to the accompanying drawings.

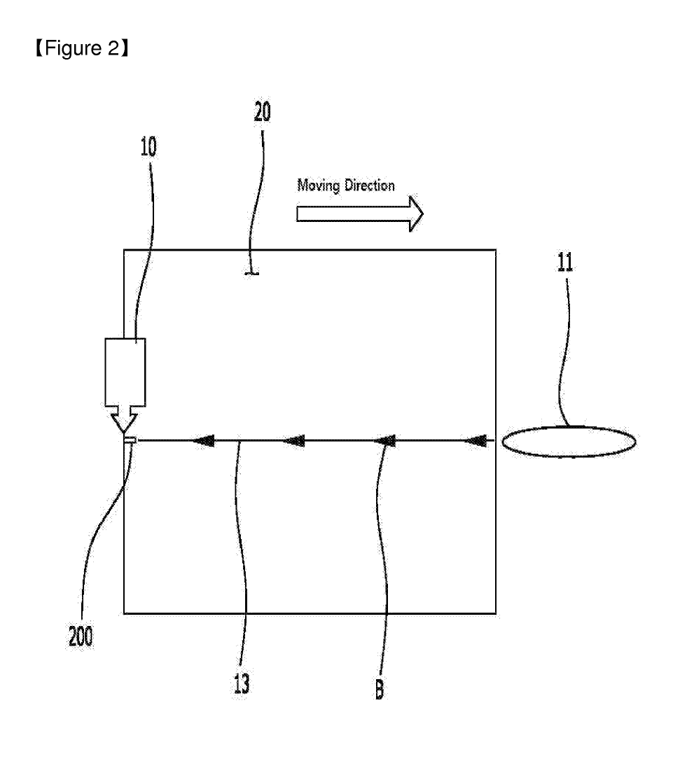

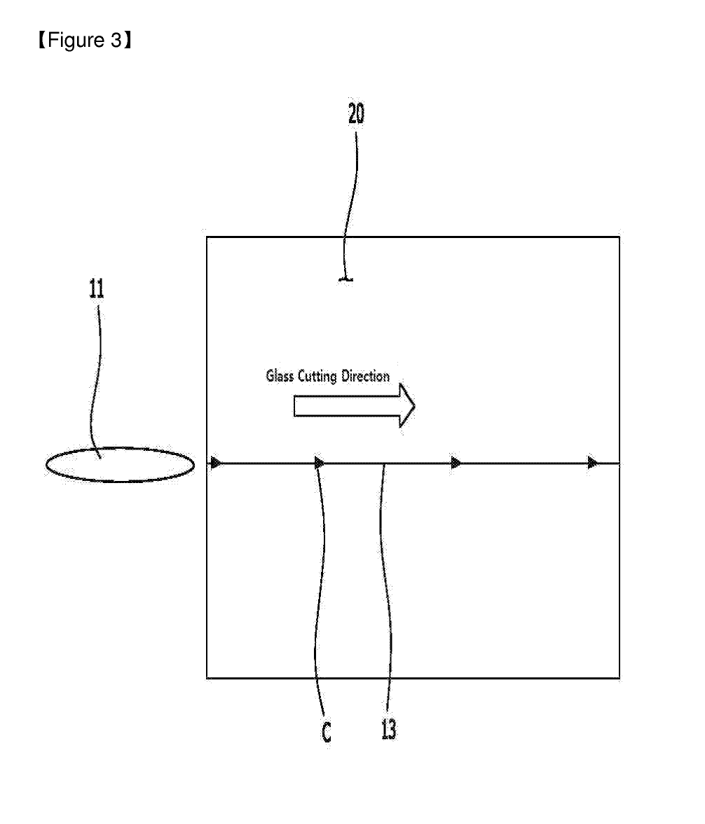

FIG. 2 is a schematic view illustrating an apparatus and a method of cutting a tempered glass substrate according to an exemplary embodiment of the present invention, and FIG. 3 is a schematic view illustrating a direction of cutting a tempered glass substrate.

Referring to FIG. 2 and FIG. 3, an apparatus of cutting a tempered glass substrate according to an exemplary embodiment of the present invention includes an initial crack generator 10, an optical heater (not shown) and a table (not shown).

A tempered glass substrate 20 is supported by the table. The table includes an element for moving the tempered glass substrate 20 supported by the table along a linear direction.

The initial crack generator 10 is assembled such that the initial crack generator 10 is disposed over the tempered glass substrate 20. The initial crack generator 10 forms an initial crack 200 at a cut-starting point of the tempered glass substrate 20.

The optical heater is assembled such that the optical heater is disposed over the tempered glass substrate 20. Further, the optical heater may be disposed over the tempered glass substrate 20 such that the tempered glass substrate 20 may move in a linear direction.

The apparatus of cutting a tempered glass substrate according to an exemplary embodiment of the present invention, which is described above, forms the initial crack 200 by using the initial crack generator 10.

After forming the initial crack 200 at the cut-starting point of the tempered glass substrate 20 by using the initial crack generator 10, a laser beam 11 for heating is irradiated onto the tempered glass substrate 20 supported by the table from a point different from the cut-starting point with the initial crack 200 to the initial crack 200 along a direction B as shown in FIG. 2 in order to generate a heated line 13.

For example, the heated line 13 may be generated by moving the table supporting the tempered glass substrate 20, while the optical heater is fixed.

Alternatively, the heated line 13 may be generated by moving the optical heater, while the table supporting the tempered glass substrate 20 is fixed.

Further, both of the optical heater and the table supporting the tempered glass substrate 20 may move in opposite direction to generate the heated line 13 in order to reduce time.

When irradiating the laser beam from the point different from the cut-starting point with the crack to the cut-staring point with the initial crack 200 of the tempered glass substrate 20 is completed by moving the optical heater, the table supporting the tempered glass substrate 20 or both of the optical heater and the table, the initial crack 200 automatically propagates from the cut-starting point with the initial crack 200 to the cut-ending point of opposite to the cut-starting point with the initial crack 200 along a direction C as shown in FIG. 3, so that cutting process is completed.

Referring again to FIG. 2 and FIG. 3, a method of cutting a tempered glass substrate according to an exemplary embodiment of the present invention will be explained.

Referring to FIG. 2 and FIG. 3, a method of cutting a tempered glass substrate according to an exemplary embodiment of the present invention, includes forming an initial crack 200 at a tempered glass substrate 20, forming a heated line 13 at the tempered glass substrate 20, and automatically propagating the initial crack 200 toward a cut-ending point opposite to the cut-starting point with the initial crack 200 along the heated line to cut the tempered glass substrate.

The initial crack 200 may be formed at a cut-starting point that corresponds to an end or an opposite end of the tempered glass substrate 20 supported by a table by using the initial crack generator 10.

The heated line 13 is generated on the tempered substrate 20 from a point different from the cut-starting point to the cut-starting point with the initial crack 200 along a direction B as shown in FIG. 2 by using the optical heater (or the laser beam 11).

For example, the optical heater (or the laser beam 11) may be irradiated on to the tempered glass substrate 20 to generate the heated line 13, while fixing the tempered glass substrate 20 and moving the optical heater from a point different from the cut-starting point to the cut-starting point with the initial crack 200, which corresponds to the end or the opposite end of the tempered substrate 20.

Alternatively, the optical heater (or the laser beam 11) may be irradiated on to the tempered glass substrate 20 to generate the heated line 13, while fixing the optical heater and moving the table supporting the tempered glass substrate 20 from a point different from the cut-starting point to the cut-starting point with the initial crack 200, which corresponds to the end or the opposite end of the tempered substrate 20.

Further, the optical heater (or the laser beam 11) may be irradiated on to the tempered glass substrate 20 to generate the heated line 13, while moving both of the optical heater and the table supporting the tempered glass substrate 20 in opposite direction from a point different from the cut-starting point to the cut-starting point with the initial crack 200, which corresponds to the end or the opposite end of the tempered substrate 20 in order to reduce time.

Through the above explained process, when the laser beam 11 being irradiated onto the tempered glass substrate 20 arrives at the initial crack 200, the initial crack 200 automatically propagates along the heated line 13, so that the tempered glass substrate 20 is cut.

According to another method of cutting a tempered glass substrate, of the present invention, the method may further include irradiating again the laser beam 11 from the cut-starting point with the initial crack 200 to a cut-ending point of the tempered glass substrate 20 after the laser beam arrives at the initial crack 200.

Especially, for the tempered glass substrate 20, it is very hard to cut without chipping or particles through the conventional mechanical cutting method. However, when the laser beam 11 is irradiated again from the initial crack to a cut-ending point of the tempered glass substrate 20 after the laser beam arrives at the initial crack 200, the tempered glass substrate 20 may be quickly and clearly cut without chipping or particles.

For example, the laser beam 11 may be irradiated from the cut-ending point of the tempered glass substrate 20 to the cut-starting point with the initial crack 200. In detail, when the initial crack 200 is formed at a first end point of the tempered glass substrate 20, the laser beam 11 may be irradiated from a second end point opposite to the first end point to the first end point in order to generate the heated line 13. For another example, the laser beam 11 may be irradiated from a point on a line between the cut-ending point and the cut-starting point to the cut-starting point to generate the heated line 13.

As described above, according to the method of cutting a tempered glass substrate, the laser beam 11 is irradiated onto the tempered glass substrate 20 from a point different from the cut-starting point with the initial crack 200 to the cut-starting point, so that the heated line 13 is formed when the laser beam 11 arrives at the initial crack 200.

Therefore, when the laser beam 11 arrives at the initial crack 200, the initial crack 200 automatically propagates from the initial crack 200 along the heated line 13 in a direction C, so that the tempered glass substrate 20 is clearly cut. As a result, it is prevented that the tempered glass substrate 20 is cut along a curved line.

Further, according to the method of the present invention, the tempered glass substrate 20 may be cut without micro crack in a sectional surface, chipping or particle only through a laser scribing process, but not through a mechanical breaking process.

Further, according to the method of the present invention, the tempered glass substrate 20 may be cut only through the laser scribing process but not through the mechanical breaking process and a cooling process using quenching nozzle, so that the number of the process for cutting the tempered glass substrate 20 is reduced to reduce a process time and a cost for manufacturing and maintaining an apparatus for cutting the tempered glass substrate 20.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of a cutting tempered glass substrate, comprising:
forming an initial crack at a cut-starting point of the tempered glass substrate;
forming a heated line at the tempered glass substrate by irradiating laser beam from a point different from the cut-starting point with the initial crack to the cut-starting point with the initial crack through optical heater; and
automatically propagating the intimal crack along the heated line to cut the tempered glass substrate.

2. The method of claim 1, further comprising:
irradiating again the laser beam from the cut-starting point with the initial crack to a cut-ending point of the tempered glass substrate after the laser beam arrives at the initial crack.

3. The method of claim 1, wherein the laser beam is irradiated onto the tempered glass substrate when the optical heater moves.

4. The method of claim 1, wherein the laser beam is irradiated onto the tempered glass substrate when the tempered glass substrate moves.

5. The method of claim 1, wherein the laser beam is irradiated onto the tempered glass substrate when the optical heater and the tempered glass substrate move in opposite direction with each other.

6. The method of claim 1, wherein the laser beam is irradiated from a cut-ending point of the tempered glass substrate to the cut-starting point with the initial crack.

7. The method of claim 1, wherein the laser beam is irradiated from a point on a line between a cut-ending point and the cut-starting point to the cut-starting point with the initial crack.

8. The method of claim 2, wherein the laser beam is irradiated onto the tempered glass substrate when the optical heater moves.

9. The method of claim 2, wherein the laser beam is irradiated onto the tempered glass substrate when the tempered glass substrate moves.

10. The method of claim 2, wherein the laser beam is irradiated onto the tempered glass substrate when the optical heater and the tempered glass substrate move in opposite direction with each other.
